(19) United States
(12) Patent Application Publication
(10) Pub. No.: US 2013/0282263 A1
(43) Pub. Date: Oct. 24, 2013

(54) Junction Adaptive Reactive Routing (JARR) Protocol for Vehicular Ad-Hoc Networks in a City Environment

(71) Applicant: Clarence Augustine Teck Huo Tee, Palo Alto, CA (US)

(72) Inventor: Clarence Augustine Teck Huo Tee, Palo Alto, CA (US)

(21) Appl. No.: 13/657,833

(22) Filed: Oct. 22, 2012

(30) Foreign Application Priority Data
Apr. 20, 2010 (MY) PI 2010001776
Feb. 17, 2011 (MY) PCT/MY2011/000012

(51) Int. Cl. G01C 21/34

(52) U.S. Cl. CPC G01C 21/34
USPC 701/118; 701/527

(57) ABSTRACT

The routing protocol was designed for VANET in a city environment. The main objective is finding not only the shortest but the most efficient path for a packet to reach its destination. Packets are routed through the fastest paths as opposed to the shortest. Fastest path is defined as the quickest time for a packet to reach a destination irrespective of distance. While the shortest path is still considered, the routing protocol adapts to the network conditions and performs routing reactively. Making use of the city topology, packets are routed from junctions to junctions. This means that routing decisions are made when a packet arrives at a junction, to decide which path to take next in order to reach the next junction. This process continues until the packet reaches its destination.

### CROSS-REFERENCE TO RELATED APPLICATIONS

The present application claims priority to PCT/MY2011/000012 filed Feb. 17, 2011, which further claims priority to Malaysian Patent Application No. PI 2010001776 filed Apr. 20, 2010, the contents of all such applications being incorporated herein by reference in their entirety.

### FIELD OF THE INVENTION

The invention relates to a novel routing protocols adapted for vehicular ad-hoc network in a city environment.

### BACKGROUND OF THE INVENTION

Vehicular ad-hoc networks (VANET) are formed when numerous vehicles participate in inter-vehicle communications (IVC) simultaneously. VANET can also consist of wireless communications with other fixed infrastructures on the roadsides. The characteristics of a city's topology pose several problems when it comes to packet routing. See, e.g., OCT 2008 C. A. T. H. Tee, et. al, “Survey of Position Based Routing for Inter Vehicle Communication System”, International Conference On Distributed Frameworks and Applications 2008 (DFmA 08), IEEE; December 2009, C. A. T. H. Tee, et. al, “Adaptive Reactive Routing for VANET In City Environments”, International Workshop on Vehicular Communications, Networks, and Applications (VCNA 2009), IEEE, Dec. 14-16, 2009, Kaohsiung, Taiwan; and APRIL 2010, C. A. T. H. Tee, “A Novel Routing Protocol—Junction Based Adaptive Reactive Routing (JARR) for VANET In City Environments”, Euro Wireless 2010, IEEE, Lucca, Italy.

### SUMMARY OF THE INVENTION

The invention uses position based routing strategy due to its advantages. In the future, more vehicles are envisioned to be equipped with GPS devices because they are useful to drivers for navigation purposes. Due to this reason, position-based routing can easily make use of this feature to assist in the routing process. Position-based routing also has high scalability and suitable for networks that involve hundreds or even thousands of nodes such as VANET. Position-based routing does not require route maintenance because routing decisions are made at the moment a packet is being forwarded. This characteristic of position-based routing is very suitable for high mobility networks such as VANET wherein the network topology changes rapidly and connection between nodes have a short lifetime.

Position-based routing method consists of different components that are beaconing, location service, forwarding strategy and recovery strategy. The invention deals with the components of beaconing, forwarding strategy and recovery strategy. The routing protocol was designed to function without fixed infrastructures and takes advantage of the city topologies that consists of many paths and junctions. The main objective is finding not only the shortest but the most efficient path for a packet to reach its destination. Packets are routed through the fastest paths as opposed to the shortest. Fastest path is defined as the quickest time for a packet to reach a destination irrespective of distance. While the shortest path is still considered, the routing protocol should adapt to the network conditions and perform routing reactively. Therefore, routing decisions must be performed actively because network topology changes rapidly in a VANET environment.

The invention involves the strategies to select a route within a vehicular ad-hoc network (VANET) in a city environment. In general, a packet would have 3 different modes, i.e., the shortest path mode, path mode and junction mode. A packet starts with the shortest path mode whereby a shortest path from the source to destination is calculated. The information obtained is used to determine the general direction that a packet should be headed and by the routing algorithm to compare the weights between the different possible junctions that a packet can be forwarded to. Then depending on the packet's current location, the packet will change to the path mode or the junction mode respectively. After that the packet will switch between path and junction mode until it reaches its destination. In these two modes, the packet could be carried and forwarded if there are no other nodes in range. At the same time, nodes forwarding the packet will receive updates such as estimated network densities from the beaconing mechanism.

The paths as well as next hops are chosen based on a calculated weighted score. The paths or next hops with the highest score will be chosen. The algorithms that calculate the scores have to take into account the vehicle's velocity, direction of travel, current position and vehicle density information. Depending on location of the vehicles and network conditions, these factors will have different weight on the algorithms. With varying algorithm in different conditions, a packet has to switch between different forwarding modes. The different modes relate to the current location of a vehicle and affect the algorithm accordingly. Besides that, packets should be transmitted through the wireless channel as much as possible. A node attempting to forward packets can hold the packets for short intervals until a connection has been established with neighbouring nodes. Adaptive beaconing is introduced to cope with situations such as network congestion when there are a lot of vehicles beaconing at the same time. The beaconing rate will be adjusted according to estimated network conditions. The beacon rate is set at a fixed rate initially. Then, information on neighbouring nodes are updated periodically. With this information as well as estimated density, the beaconing rate was adjusted accordingly.

Estimating density of a path is part of the beaconing mechanism. The beaconing rate is determined by information gathered from one hop neighbours. The same information can also be used to estimate the density of a path since the beaconing rate is affected by the density and density is affected by velocity. With information on velocity of nodes, the density on a path can be estimated. However, it is possible that even in a sparse condition, vehicles would move at a slow speed. Hence, both the beaconing rate and the velocity of vehicles are used to estimate the density on a certain path.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1: Different modes in JARR routing model.

FIG. 2: Notations for path mode's delay model.

FIG. 3: Notations for junction mode's delay model.

FIG. 4: General pseudo-code for adaptive beaconing.

FIG. 5: General flow to estimate density of a path.

FIG. 6: General pseudo-code for estimating density on a path.

FIG. 7: Example scenario of forwarding packet in a path.

FIG. 8: Example scenario of looping in sparse network.

FIG. 9: General pseudo-code for path mode.

FIG. 10: Example scenario for path selection.

FIG. 11: Example scenario of node selection on a junction.

FIG. 12: Example scenario of looping at a junction.

FIG. 13: Example of worst case scenario at a junction.

FIG. 14: General pseudo-code for junction mode.

FIG. 15: Example scenario of out of transmission range for short interval.

FIG. 16: Example scenario of forwarding node having the highest score.

FIG. 17: Example scenario of packet forwarding past a junction.

FIG. 18: Packet delivery ratio versus number of connections in dense network.

FIG. 19: Packet delivery ratio versus number of connections in sparse network.

FIG. 20: Packet delivery ratio versus number of nodes with 10 connections.

FIG. 21: Overhead packets versus number of nodes.

FIG. 22: Overhead packets versus number of connections.

FIG. 23: End-to-end delay versus number of nodes with 8 connections.

FIG. 24: End-to-end delay versus number of nodes with 20 connections.

FIG. 25: Number of hops versus number of nodes with 8 connections.

FIG. 26: Number of hops versus number of nodes with 20 connections.

TABLE 1: Estimated density of path.

TABLE 2: Ratio between position and direction weights.

TABLE 3: Varying simulation parameters used for behavior evaluation.

TABLE 4: Simulation parameters used for performance evaluation.

TABLE 5: Average PDR for 36 km/h with varying number of nodes.

TABLE 6: End-to-end delay for high velocity in sparse network.

TABLE 7: Average overhead packets comparing fixed beaconing with adaptive beaconing.

TABLE 8: Average number of hops in sparse and dense networks.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

JARR Routing Model

This section describes an overview of the routing model implemented by JARR in order to improve routing for VANET in a city environment. Due to the high mobility of the VANET environment, the network topology changes rapidly. Routing protocols such as C. Lochert, H. Hartenstein, J. Tian, H. Füβler, D. Herrmann, and M. Mauve, “A Routing Strategy for Vehicular Ad Hoc Networks in City Environments,” Proceedings of the IEEE Intelligent Vehicles Symposium (IV2003), Ohio, USA, June 2003, pp. 156-161, G. Liu, B. S. Lee, B. C. Seet, et al, “A Routing Strategy for Metropolis Vehicular Communications,” ICOIN 2004, Nanyang Technological University, University of Edinburgh, 2004, pp. 134-143, and B. Karp and H. T. Kung, “GPSR: Greedy Perimeter Stateless Routing for Wireless Networks,” Proceedings of ACM/IEEE MOBICOM'00, Boston, Mass., USA, 2000, pp. 243-254. that relied on connected planar graphs would not be suitable because with high mobility and radio interferences in a city environment, connections among nodes would have limited lifetime. Hence, JARR was designed to perform packet forwarding decisions reactively because pre-determined paths tend to either become stale rapidly or are not the optimal paths. This is done by taking into account the direction and velocity of travelling nodes as well as other network conditions.

The routing protocols proposed by G. Liu, B. S. Lee, B. C. Seet, et al, “A Routing Strategy for Metropolis Vehicular Communications,” ICOIN 2004, Nanyang Technological University, University of Edinburgh, 2004, pp. 134-143, R. Morris, J. Jannotti, F. Kaashoek, J. Li and D. Decouto, “CarNet: A Scalable Ad Hoc Wireless Network System,” Proceedings of the 9th ACM SIGOPS European Workshop, September 2000 and B. Karp and H. T. Kung, “GPSR: Greedy Perimeter Stateless Routing for Wireless Networks,” Proceedings of ACM/IEEE MOBICOM'00, Boston, Mass., USA, 2000, pp. 243-254. also used the shortest path strategy. This method of routing is simple to be implemented but it does not consider whether a path is populated with vehicles in order to forward packets. To improve this, JARR was designed to adapt with the network environment by considering the estimated density of paths to be taken. This is different from the approach proposed in M. Jerbi, S.-M. Senouci, Y. G.-Doudane and R. Meraihi, “GyTAR: Improved Greedy Traffic Aware Routing protocol for Vehicular Ad hoc Networks in City Environments,” Poster: The Third ACM International Workshop on Vehicular Ad Hoc Networks (VANET 2006), Los Angeles, Calif., USA, September 2006, pp. 88-89. whereby predicted node positions were used to choose better next hops but with the anchor-based method C. Lochert, H. Hartenstein, J. Tian, H. Füβler, D. Herrmann, and M. Mauve, “A Routing Strategy for Vehicular Ad Hoc Networks in City Environments,” Proceedings of the IEEE Intelligent Vehicles Symposium (IV2003), Ohio, USA, June 2003, pp. 156-161, and G. Liu, B. S. Lee, B. C. Seet, et al, “A Routing Strategy for Metropolis Vehicular Communications,” ICOIN 2004, Nanyang Technological University, University of Edinburgh, 2004, pp. 134-143.

Alternatively, M. Mauve, H. Füβler, H. Hartenstein and C. L Lochert, “Geographic Routing in City Scenarios,” ACM SIGMOBILE Mobile Computing and Communications Review (MC2R), Vol. 9, Issue 1, January 2005, pp. 69-72, W. Sun, H. Yamaguchi, K. Yukimasa, and S. Kusumoto, “GVGrid: A QoS Routing Protocol for Vehicular Ad Hoc Networks,” IEEE IWQoS, 2006 and Y. Ding, C. Wang, and L. Xiao, “A Static-node Assisted Adaptive Routing Protocol in Vehicular Networks,” Proceedings of the 4th ACM International Workshop on Vehicular Ad Hoc Networks, Montreal, Quebec, Canada, September, 2007, pp. 59-68 proposed routing protocols that required fixed infrastructures to assist in the routing process. These protocols were able to produce better results with the help of repeaters and fixed nodes to forward packets at junctions. However JARR was opted to be implemented without the need of fixed infrastructures to support the high scalability of a VANET environment. Deployment would be easier without the need to install certain equipment at the road sides.

As mentioned earlier, beaconing is a component of position-based routing. However, protocols such CBF (H. Füβler, H. Hartenstein, J. Widmer, M. Mauve and W. Effelsberg, “Contention-Based Forwarding for Street Scenarios,” Proceedings of the 1st International Workshop on Intelligent Transportation (WIT), Hamburg, Germany, March 2004, pp. 155-160) and UMB (G. Korkmaz, E. Ekici, F. Özgüner and Ü. Özgüner,“Urban MultiHop Broadcast Protocol for Inter Vehicle Communication Systems,” First ACM Workshop on Vehicular Ad Hoc Networks (VANET 2004), Philadelphia, USA, October 2004) were designed without the use of the beaconing component. This was with the reasoning that beaconing would produce significant amount of non data packets. Nevertheless, JARR was designed with the use of beaconing due to its advantage of being able to retrieve various updated information from time to time. In order to reduce the potential high amount of non data packets generated, an adaptive beaconing mechanism was used whereby the rate of beaconing would adjust based on current network conditions. For example, higher beaconing rates were used in a sparse network to identify forwarding nodes faster and reduce the delay.

Both routing protocols, M. Jerbi, S.-M. Senouci, Y. G.-Doudane and R. Meraihi, “GyTAR: Improved Greedy Traffic Aware Routing protocol for Vehicular Ad hoc Networks in City Environments,” Poster: The Third ACM International Workshop on Vehicular Ad Hoc Networks (VANET 2006), Los Angeles, Calif., USA, September 2006, pp. 88-89 and M. Abuelela and S. Olariu, “Traffic-Adaptive Packet Relaying in VANET,” Poster: Proceedings of the 4th ACM International Workshop on Vehicular Ad Hoc Networks, Montreal, Quebec, Canada, September 2007, pp. 77-78 used a type of carry and forward strategy (J. Davis, A. Fagg and B. Levine, “Wearable Computers as Packet Transport Mechanisms in Highly-Partitioned Ad-Hoc Networks,” International Symposium on Wearable Computing, October 2001) that produced reasonable results. However high delay would occur if packets were carried by vehicles for too long. JARR also used the carry and forward strategy but only in cases whereby vehicles were out of transmission range or line of sight was not available for short intervals only.

The routing protocol TAPR M. Abuelela and S. Olariu, “Traffic-Adaptive Packet Relaying in VANET,” Poster: Proceedings of the 4th ACM International Workshop on Vehicular Ad Hoc Networks, Montreal, Quebec, Canada, September 2007, pp. 77-78 was designed with two modes, i.e., disconnected and connected and switched between these modes according to the network topologies. Similarly, JARR also implemented a packet routing with different packets modes which can adapt to the sparse and dense network conditions. Here the shortest path mode in JARR was introduced to assist in obtaining initial directions for packets to travel. Furthermore, the shortest path was also used to compare with the other possible paths to obtain an optimal path as well as part of the recovery strategy when the fastest paths could not be determined. The packets then switched to either path mode or junction mode depending on the packets' current location.

(a) Assumptions

The JARR routing model was designed based on these necessary assumptions and specifications. These assumptions were made with respect to the network environment, road topology and applications involved as well as the position-based routing requirements.

JARR was designed for applications that require multi-hop data routing in a VANET environment. There are many types of VANET applications that would benefit from multi-hop routing due to their abilities to extend beyond a driver's line of sight and range of view. JARR routing protocol also focused on the city environment whereby there are a lot of obstacles that cause communication line of sights and radio interferences. Vehicle movements are also restricted by the road topology that consists of many paths and junctions. However this factor can be used as an advantage for the routing protocol as vehicle movements can then be predictable to certain extend. For the city environment, the average number of vehicles was also assumed to be reasonable on most paths. In addition, the paths traveled were also assumed to be two directional multi-lane traffic. Hence the direction of traffic movements will also be considered when performing routing.

Vehicles are able to communicate using wireless devices up to the range of 250 meters. The most important information required for position-based routing is the location information. Vehicles were assumed to be able to obtain this information via GPS devices or other position determining techniques. However, using GPS that can be equipped with digital maps is more reliable and foreseen to be widely available in the future. The costs of these devices can be justified with the wide range of other applications they provide. For the position-based routing component, the location service was also assumed to be available. This was to ease the simulation process because the main concern was the packet forwarding process and the reliability of data delivery. Additionally, the routing protocol was also designed without the need of fixed infrastructures in order to assist in the routing process. This was to allow the network to be easily scalable to accommodate large number of vehicles as well as easy to deploy. Lastly, the sparse and dense conditions of the network have to be considered to tackle problems that would occur in these conditions.

(b) General Routing Model

JARR routing protocol adheres to a set of general rules when performing routing. These rules are the important factors that affect the overall behavior of the routing protocol. The main objective is finding not only the shortest but the most efficient path for a packet to reach its destination. Packets are routed through the fastest paths as opposed to the shortest. While the shortest path is still considered, JARR should adapt to the network conditions and perform routing reactively. Therefore, routing decisions must be performed actively because network topology changes rapidly in a VANET environment. Then, making use of the city topology, packets are routed from junctions to junctions. This means that routing decisions are made when a packet arrives at a junction, to decide which path to take next in order to reach the next junction. This process continues until the packet reaches its destination.

The paths as well as next hops are chosen based on a calculated weighted score. The paths or next hops with the highest score will be chosen. The algorithms that calculate the scores have to take into account the vehicle's velocity, direction of travel, current position and vehicle density information. Depending on location of the vehicles and network conditions, these factors will have different weight on the algorithms. With varying algorithm in different conditions, a packet has to switch between different forwarding modes. The different modes relate to the current location of a vehicle and affect the algorithm accordingly. This is to ensure routing decisions can be made on-the-fly in different network conditions.

Besides that, packets should be transmitted through the wireless channel as much as possible. However, whenever this is not possible due to obstacles and blind spots, the node attempting to forward the packets can hold the packets for a short interval until a connection has been established with neighboring nodes. Also, in a sparse area where the density of vehicles is low, the best path is chosen where vehicles can carry and forward packets to the next junction. Several other conditions for a packet to be carried are also considered but are only used as a last option.

Lastly, the beaconing component would be used in the routing model. However, adaptive beaconing is introduced to cope with situations such as network congestion when there are a lot of vehicles beaconing at the same time. The beaconing rate will be adjusted according to estimated network conditions.

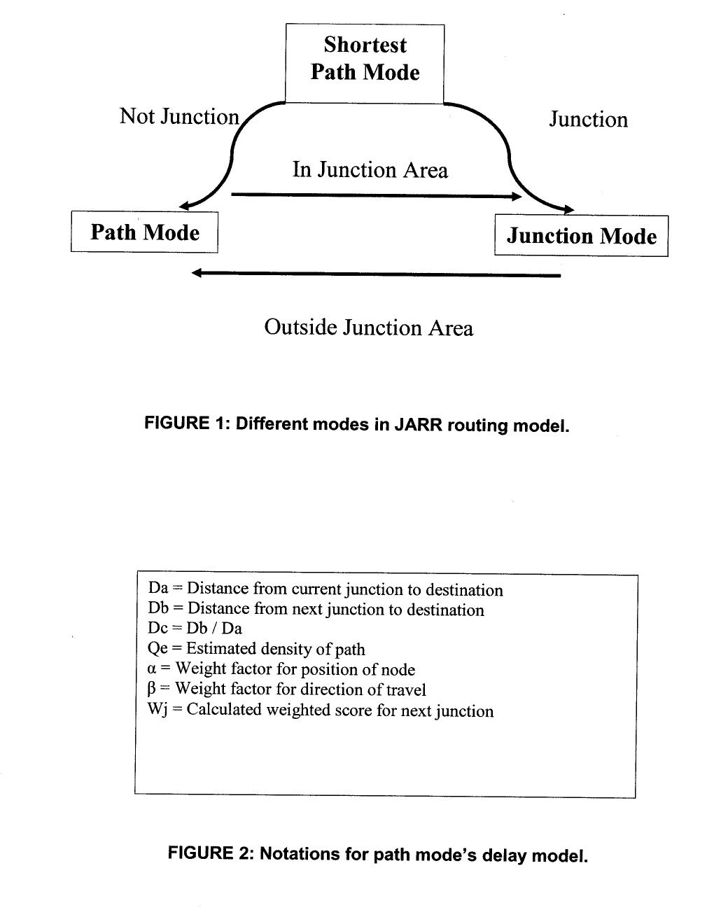

The general idea of JARR routing model can be viewed in terms of the change in packet modes. A packet changes between different modes in order to adapt to the different network conditions and to pick the best possible route from source to destination. FIG. 1 shows the simplified JARR routing model switching between the different modes. At the start of a transmission, a packet could be on a path or a junction. The shortest path from the source to the destination is calculated in the beginning to get a general direction of where a packet should be forwarded. The packet then switches to its specific mode depending on its current location. In all the modes, information of neighboring nodes are being gathered periodically. These information facilitate in making routing decisions and estimating the density of vehicles on a path.

(c) Optimal Path Model

The vehicular ad-hoc network is represented as a directed graph G (V, E) with sets of vertices V, connected by edges E. V represents the set of junctions on the road connected by the edges E that represents the set of directional roads connecting these junctions. The weights on the edges represent the distance between two junctions. Then, Dijkstra's algorithm (E. W. Dijkstra, “A note on two problems in connexion with graphs,” Numerische Mathematik, 1, 1959, pp. 269-271) is used to calculate the shortest paths from the junctions where a source node is on, to the destination junctions. The results would determine the shortest sequence of junctions that a packet would have to take in order to reach its destination. The route obtained would be for ideal situations whereby the distribution of vehicles are sufficient with no network disconnections and obstacles. However this is seldom the case hence, the information obtained is only used to obtain the initial direction of travel and to assist in comparing the next set of junctions and paths to take.

The weights on the edges E represents the possible delays that a packet might get if it travels on certain edges. Due to the changing traffic conditions, the weights are not constant. Therefore it is not possible to calculate the overall delay for a packet from its source to destination. However it is possible to calculate the possible delay for a packet from a junction to another. Different delay model are used for the path and junction modes respectively because different factors have to be considered. For path mode, the forwarding process has to consider a node's velocity, direction of travel, current position and distance to the next junction. FIG. 2 shows the notations used to define the delay model for path mode.

Using these notations, the delay on a path is defined by

Wp=α(1−Dk)+β(Vi). (1)

The value of Dk is used to determine the proximity of a node to the targeted junction. A node with shorter distance would have higher priority. The values of α and β adds up to 1 and their ratio is adjusted based on the estimated density of the network. The vector for the velocity of the nodes is also considered and influenced by the weight factor of the direction. By considering the position and direction information, an optimal next hop can be obtained.

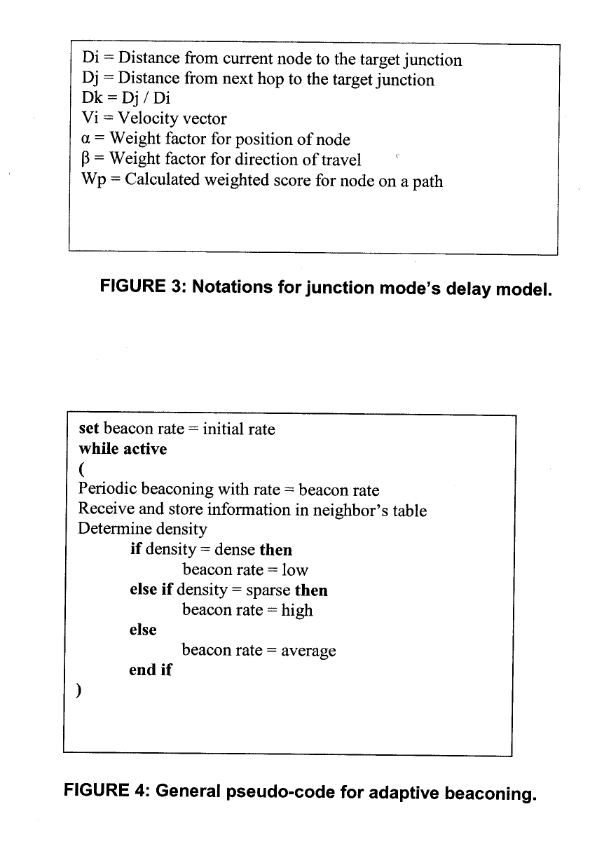

For junction mode, the forwarding process has to decide a path to take in order to reach the next junction. FIG. 3 shows the notations used to define the delay model for junction mode. The distances to the next and destination junctions as well as the density of the path to the next junction are considered. The distances of the paths can be obtained using the shortest path model.

Using these notations, the algorithm to choose the path and junction is defined by

Wj=α(1−Dc)+β(Qe). (2)

The value of Dc is used to determine the proximity of the next junction to the final destination junction. This is to avoid a junction that is further away from the destination from being chosen. In the case whereby paths have similar density, the junction that is closer to the destination can also be chosen. The values of α and β adds up to 1 and is adjusted based on the estimated density information obtained.

(c) JARR Routing Protocol

JARR is a position-based routing protocol that includes different components such as beaconing, location service, forwarding strategies and recovery strategies. This section describes the different components that were adjusted for JARR.

Adaptive Beaconing

Researches such as by H. Füβler, H. Hartenstein, J. Widmer, M. Mauve and W. Effelsberg, “Contention-Based Forwarding for Street Scenarios,” Proceedings of the 1st International Workshop on Intelligent Transportation (WIT), Hamburg, Germany, March 2004, pp. 155-160 and G. Korkmaz, E. Ekici, F. Özgüner and Ü. Özgüner, “Urban MultiHop Broadcast Protocol for Inter Vehicle Communication Systems,” First ACM Workshop on Vehicular Ad Hoc Networks (VANET 2004), Philadelphia, USA, October 2004 have proposed beaconless position-based routing due to concerns on network congestions. However, beaconing is an important mechanism for a node to announce its presence in the network as well as to gather information from nodes that are within its transmission range. With beaconing, nodes are able to gather updates on the conditions of networks and then adapt based on the information obtained. Therefore, a good trade off would be to introduce an adaptive beaconing mechanism.

The beaconing mechanism is used to obtain neighboring nodes' information such as their position, velocity, direction of travel and beaconing rate. With these information, the beaconing rate of a node is adjusted based on the estimated density obtained.

FIG. 4 shows the general pseudo code for the adaptive beaconing mechanism. The beacon rate was set at a fixed rate initially. Then, information on neighboring nodes was updated periodically. With this information as well as estimated density, the beaconing rate was adjusted accordingly. The beaconing rate corresponding to each estimated density was determined beforehand by performing behavior simulations that would be explained in the simulation chapter.

Path Density Estimation

Estimating density of a path is part of the beaconing mechanism. The beaconing rate is determined by information gathered from one hop neighbors. The same information can also be used to estimate the density of a path since the beaconing rate is affected by the density and density is affected by velocity. With information on velocity of nodes, the density on a path can be estimated. However, it is possible that even in a sparse condition, vehicles would move at a slow speed. Hence, both the beaconing rate and the velocity of vehicles are used to estimate the density on a certain path. The beaconing rate starts off with an initial rate. Then, the beacon rate of a node is determined by the node densities around it. This means that by obtaining the beaconing rate information of a node, the density information around that node can also be obtained.

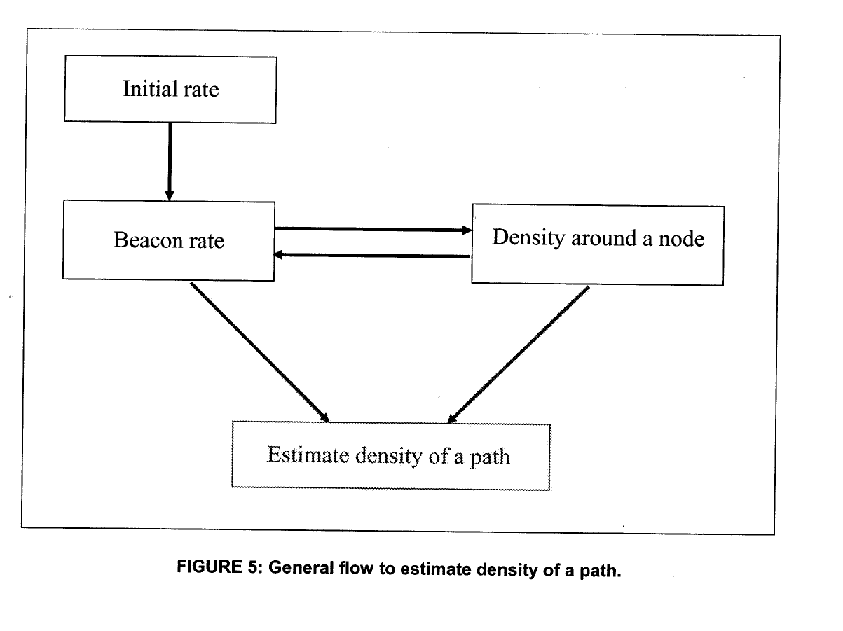

FIG. 5 summarizes the general flow to estimate density of a path. The beacon rate and density around a node are related and affects one another. The beacon rate of a node is determined by the node densities around it. This means that by obtaining the beaconing rate information of a node, the density information around that node can also be obtained. With this information, the density of a path could then be estimated.

The possible output for the estimated density on a path is summarized in Table 1. According to National Speed Limit Malaysia. (2009, September). Retrieved May 5, 2009, from Wikipedia: http://en.wikipedia.org/wiki/National_Speed_Limits_(Malaysia) the road speed limit for Malaysia is 60 km/h in a town area and up to 90 km/h depending on geographical factors along the roads of a city. The velocities for slow, average and fast moving vehicles were estimated based on this information.

From the table, it can be seen that the estimated density on a path is mostly affected by the beaconing rate. However, for slow beaconing rate with fast and average velocities, the estimated density is still average and not dense. Based on the study of Y. Sugiyama, M. Fukui, M. Kikuchi, K. Hasebe, A. Nakayama, K. Nishinari, S. Tadaki and S. Yukawa, “Traffic jams without bottlenecks—experimental evidence for the physical mechanism of the formation of a jam,” New Journal of Physics, 10(033001), 7, March 2004, the velocities of vehicles on the road do not reduce drastically based on density of the vehicles until a critical density threshold has been reached. It was observed that a traffic jam would occur even without obstacles or bottlenecks simply because the road's capacity has been reached. The results from the real world experiment performed in Y. Sugiyama, M. Fukui, M. Kikuchi, K. Hasebe, A. Nakayama, K. Nishinari, S. Tadaki and S. Yukawa, “Traffic jams without bottlenecks—experimental evidence for the physical mechanism of the formation of a jam,” New Journal of Physics, 10(033001), 7, March 2004 showed that vehicles were able to move freely at around 40 km/h even with a lot of vehicles as long as the critical threshold has not been reached. When a traffic jam occurred, the velocities of vehicles measured were commonly around 20 km/h. Hence, in this research it was assumed that vehicles were still able to move at reasonable speed even with a lot of vehicles.

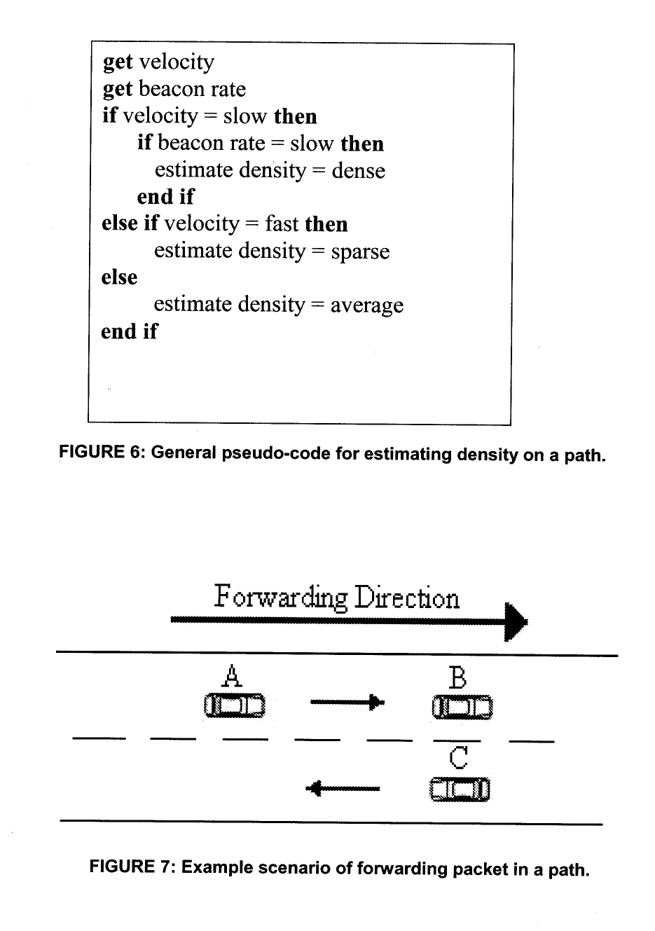

With this information, the pseudo code for density estimation is presented in FIG. 6. The pseudo code was derived with the use of information from Table 1.

Path Mode Routing Protocol

A packet in the path mode is travelling between two junctions, with one of the junctions as its intermediate destination. The main aim is to reach its intended junction with the least delay by selecting the next best hop. While using the greedy forwarding method would be the easy solution, it is not feasible for two directional roads. Besides that, by considering the direction of traffic, there are also certain scenarios that have to be looked into.

An example scenario is presented in FIG. 7. In this example, in order to forward a packet in the forwarding direction, node A can pick between forwarding to node B or node C. In this case, the packet should be forwarded to node B because it is moving in the same direction. Hence, the algorithm should have direction on a higher weight for this scenario. However, with further review of the scenarios, the algorithm would not be as complicated as it seems as long as it adheres to the general routing model.

Other scenarios considered were paths with average densities of vehicles. In these scenarios, a vehicle might be able to move with a high velocity even though there is an average density of vehicles due to one sided traffic jams. Nevertheless, the routing model states that a packet should be forwarded through wireless as much as possible. Therefore in these cases, it is still faster to forward a packet based on the position of a node and not the direction even though a node could be moving at high velocity. The position of a node should then have a higher influence on the calculated weighted score.

In scenarios with high densities of vehicles, the fastest way for a packet to travel in the forwarding direction is by having position as a higher priority. This would be similar to the greedy forwarding strategy. However, the travel direction of nodes is also considered in the case where two vehicles are moving in opposite directions and parallel to one another. For this case, the weight for position should have the highest ratio while still considering the moving direction of nodes with a small ratio.

Nevertheless, when a packet is near a junction, it is favorable if a node is moving in the same direction in order to avoid having to forward to another node that is on the junction and minimize the number of hops. This is also one of the reasons that the distance of a node from a junction is considered in the algorithm.

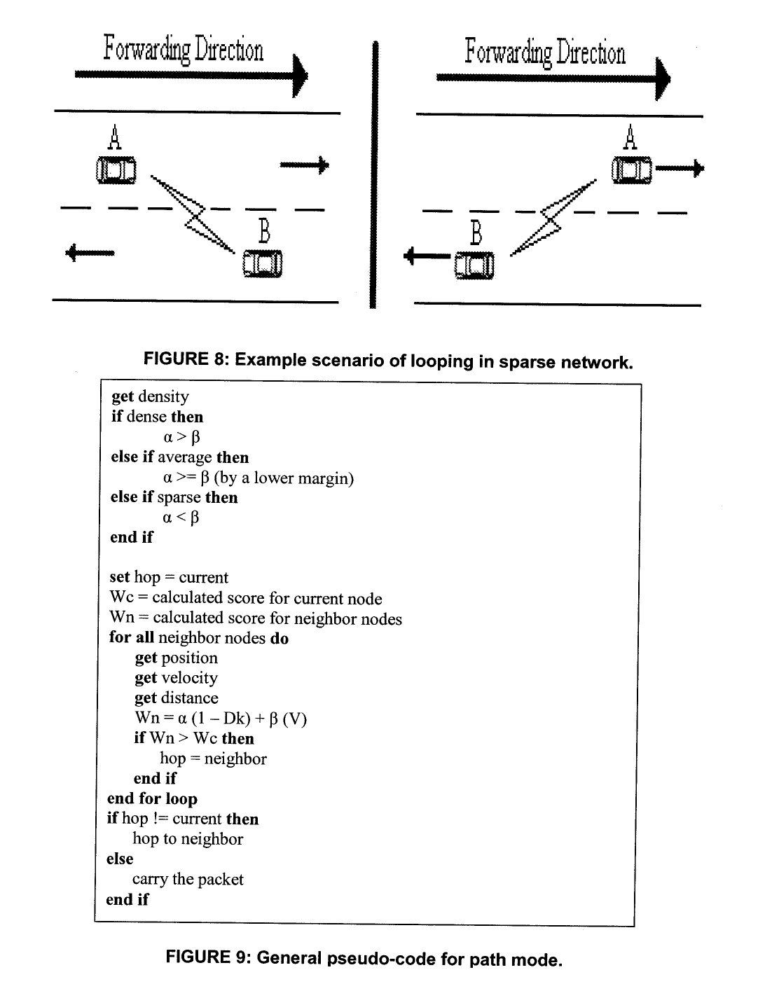

FIG. 8 shows a sequence of movements by vehicles on a path with low density, which could cause looping to occur. In the example, node A forwards a packet to node B that is moving in the opposite direction. Since there are no other vehicles for node B to forward the packet to in the forwarding direction, it might end up forwarding the packet back to node A after the two nodes have overtaken each other. This has caused looping to occur and wasted network resources. Therefore, the weight for direction of travel should have a higher ratio in order for node A to obtain the highest calculated score among the two nodes. Node A can then refrains from forwarding and carries the packet longer. However, this would depend on the velocity of the nodes and also the density condition of the network. The algorithm hence considers the direction of travel and velocity of the nodes.

The pseudo code for path mode is shown in FIG. 9. It was derived by considering the different scenarios that might occur when vehicles are travelling on a path. The ratio of α and β is affected by the density of the path. Then, the packet will be forwarded to neighbor nodes that have the highest calculated weighted score. If no other nodes have a highest score, the current node will carry the packet.

Junction Mode Routing Protocol

For junction mode, it is slightly more complicated. First of all, a node has to select the optimal path to forward a packet to. This is essentially also selecting the next junction to forward a packet to and is performed by using the junction selection algorithm. Then, the node has to select a suitable node to forward the packet towards the next selected junction.

For the path selection, the estimated density information would be used in the selection process. Upon reaching a junction, the node has to probe nodes on other paths to obtain the information on estimated density. This is performed by using the beaconing mechanism. In the event that there are no nodes on a certain path, the path would be considered at a lower priority. However at the same time the distances of the possible junctions to the destination are considered as well in the algorithm. This is to avoid packets being forwarded in the opposite directions away from the final destinations. If at the time of probe there are no vehicles on any path, the node will attempt to forward the packet to the shortest path.

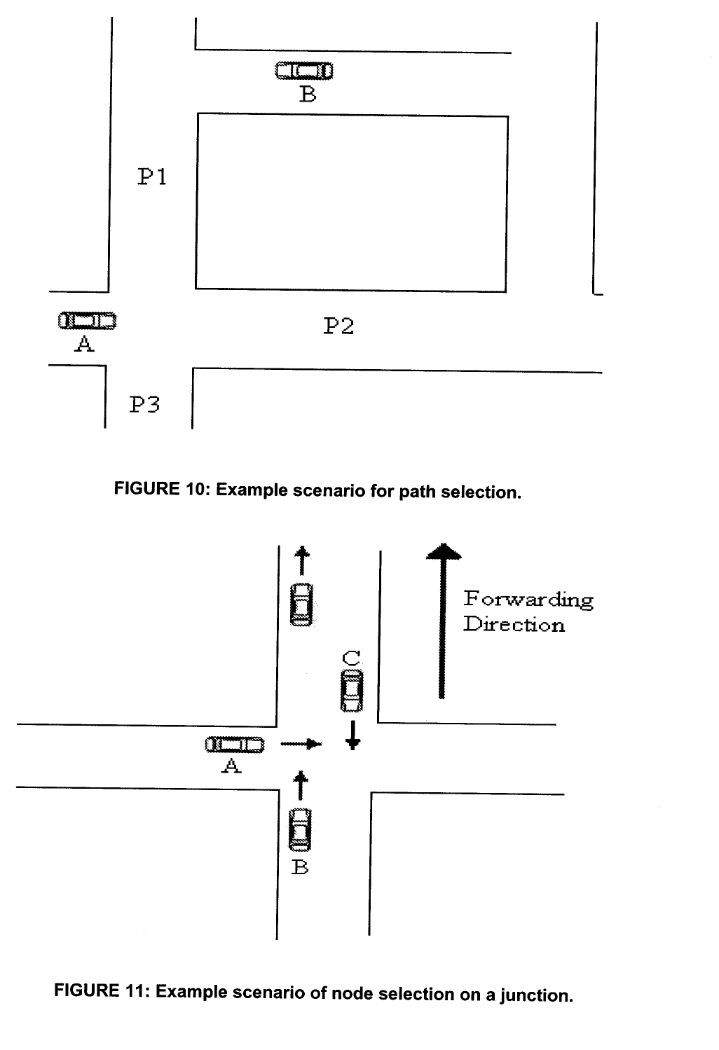

FIG. 10 shows an example of a path selection scenario. In the example, node A is attempting to send a packet to node B. Assuming the paths of P1, P2 and P3 are populated with vehicles, node A will attempt to forward the packet to the path P1 because its overall distance is shorter as compared to P2. The packet will not be forwarded to P3 because it would be moving much further from the destination.

After a path has been selected using the junction selection algorithm, a node has to be chosen to forward the packet towards the selected junction. Here is where some problems would arise. Due to unpredictable driver behavior and traffic conditions, it is difficult to ensure that vehicles near a junction would turn towards the selected path.

FIG. 11 shows an example scenario of node selection on a junction. In the scenario, node A has already chosen the path that is in the forwarding direction. The first choice to forward a packet to would be node C because it is moving on the selected path. However due to node C moving in the opposite direction, node B could also be a possible candidate. At the same time there is no guarantee that node B would be moving in the selected path.

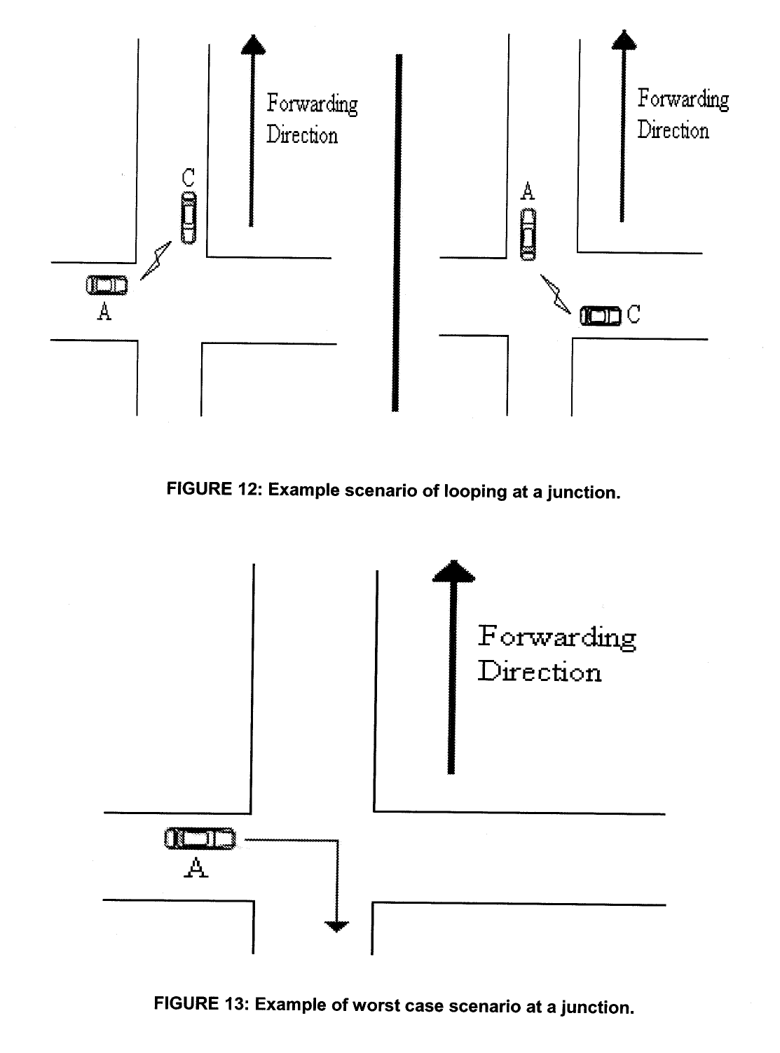

Besides that, FIG. 12 shows another scenario that would occur when selecting forwarding nodes at a junction. In the example, node A attempts to forward a packet towards the forwarding direction by forwarding to node C. However, since there are no other nodes for node C to forward the packet, the packet might just end up being forwarded back to node A. This would cause a packet to be forwarded back and forth at a junction.

An example of a worst case scenario is shown in FIG. 13. This happens when a node is unable to locate another node to forward a packet to the forwarding direction. If the node carrying the packet turns to another direction, the packet might get lost. In order to solve this, a packet might be intentionally forwarded through several loops at the junction, until a suitable node has been located to forward the packet in the forwarding direction.

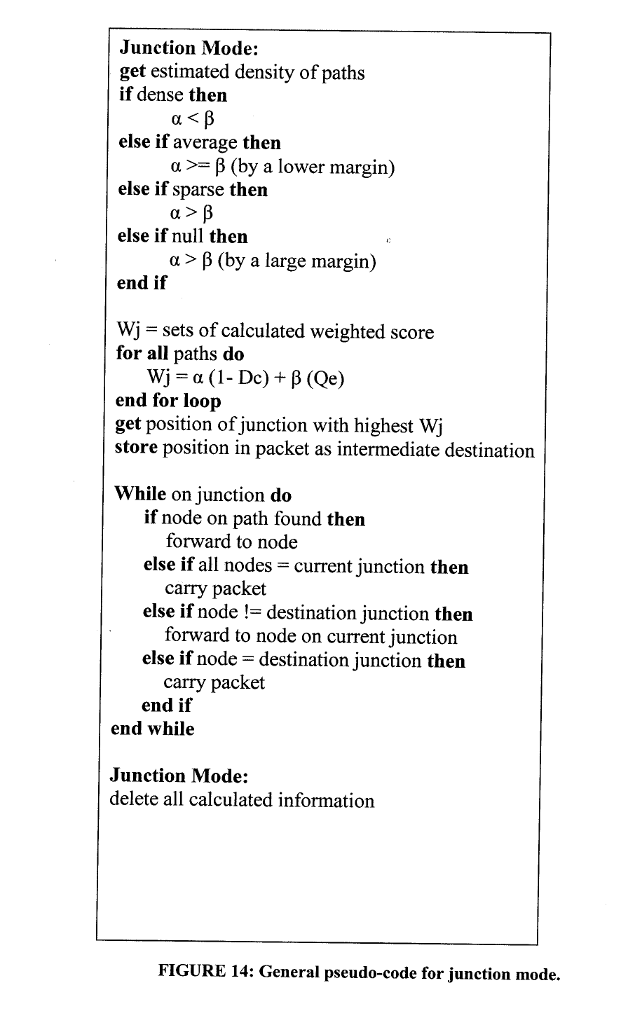

The pseudo code for junction mode is shown in FIG. 14. It was derived by considering the different scenarios that might occur when a vehicle approaches and arrives at a junction. The ratio of α and β is affected by the estimated densities of the paths. The information is then used to calculate the weighted score for each path. After a path has been selected, the position information of the next junction is stored in the packet. The node then attempts to locate a suitable node to forward the packet by first, searching for nodes that is located on the selected path. If those nodes are not available, secondary measures are taken to ensure that the packet would be at the junction and forwarded as soon as possible towards the selected junction.

Recovery Strategy

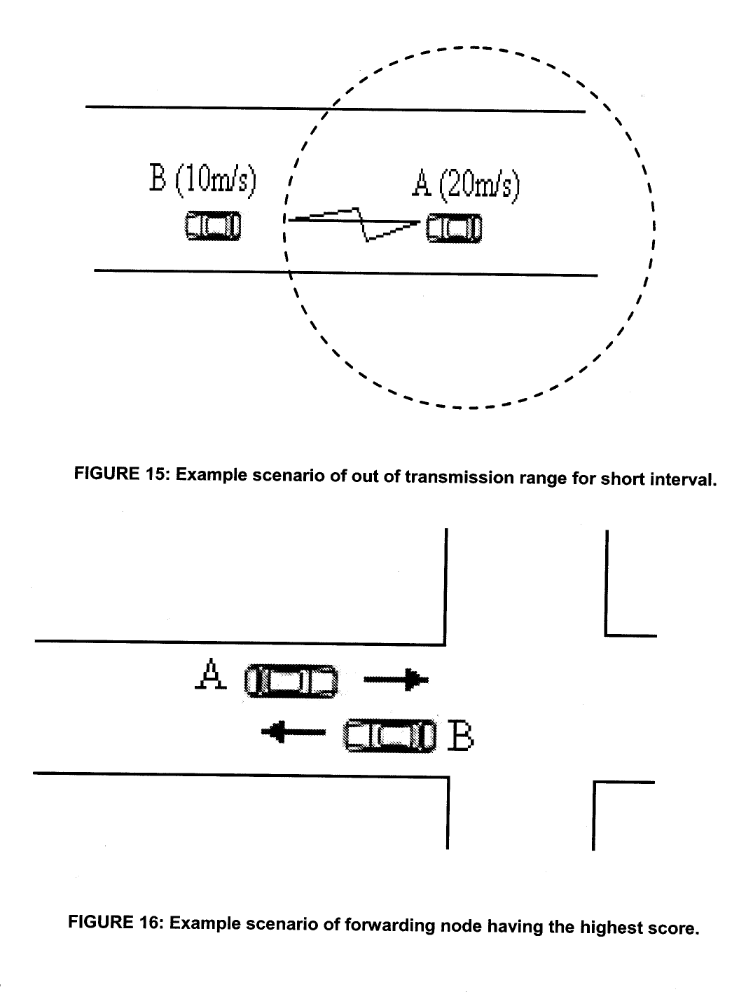

The recovery strategy is incorporated into the path and junction modes respectively. There are however certain constraints and scenarios that needs to be considered. The recovery strategy of carry and forward is mostly used in situations such as shown in FIG. 15. In the example, node A is not able to reach node B due to the limited transmission range. However with the difference in velocity, node A would be able to transmit to node B in a short interval. Therefore, the packet would be carried by node A for a short interval until it is in transmission range of node B.

The other condition whereby the recovery strategy is used is when a forwarding node simply having a higher calculated weighted score. This could be due to the node moving at a higher velocity in a sparse network or the node moving at a direction with less traffic. FIG. 16 shows an example scenario of a forwarding node having a higher calculated score. In the example, node A is the forwarding node and its next option is to forward the packet to node B that is close to the junction. However, node B is moving away from the junction while node A would be at the junction in a short interval. Therefore node A would choose to carry the packet and forward it later at the junction.

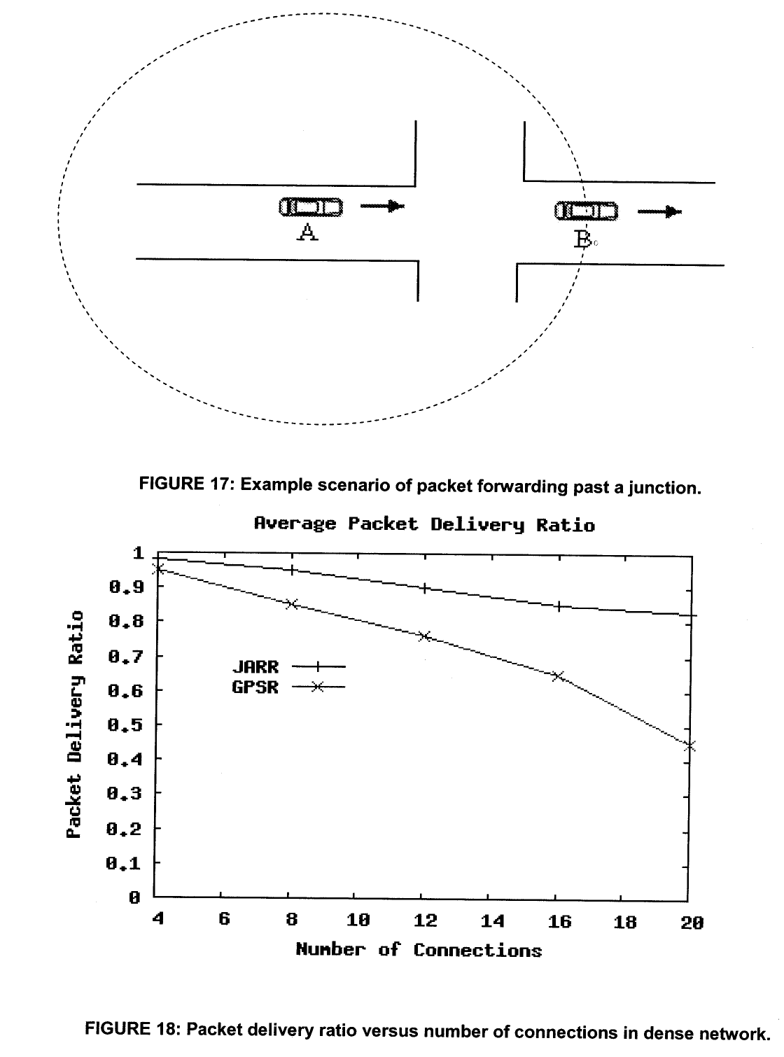

Another scenario whereby the carry and forward strategy would be used is shown in FIG. 17. In the example, the packet in node A is still in the path mode. For node A, the only node in range of transmission is node B. However the position of node B is beyond the targeted junction and also moving away from the junction. Therefore, node A has no choice but to carry the packet for a short interval until it reaches the junction to decide on the next steps to be taken.

Simulations and Evaluations

This section presents the simulation setup and parameters used in order to evaluate the routing protocol. The well-known network simulator NS-2 NS-2, “The Network Simulator—Ns2,” April 2008 [Online], Available: http://www.isi.edu/nsnam/ns/, [Accessed: 20 April, 2008] was used to perform the simulations. Behavior and performance evaluations were conducted. Behavior evaluation was performed to fine tune the parameters of JARR and to observe its performance in different scenarios. As for performance evaluation, JARR protocol was compared with an existing routing protocol, Greedy Perimeter Stateless Routing (GPSR) B. Karp and H. T. Kung, “GPSR: Greedy Perimeter Stateless Routing for Wireless Networks,” Proceedings of ACM/IEEE MOBICOM'00, Boston, Mass., USA, 2000, pp. 243-254.

Simulation Setup

Simulations were conducted in a map size of 3.0 km×3.0 km with a total of up to 500 nodes. The nodes communicate using the IEEE 802.11 wireless LAN standard with a maximum range of 250 m. The nodes move at an average velocity of up to 25 m/s. The initial beaconing rate is set to 0.5 s. For these simulations, a simple traffic model is used to generate communications among nodes. Data packets are streamed among nodes using Constant Bit Rate (CBR) whereby packets are sent continuously until transmission is stopped. Connection rate is fixed at 0.25 s that is 4 packets per second, with packet sizes of 512 bytes. The transmission time between nodes varies depending on the simulation models. However analysis of simulation results are based on a fixed number of packets sent. The maximum number of connections allowed at one time is also varied because it affects the number of packets generated in the whole network. This can be used to evaluate the performance of the routing protocol such as during network congestions. With this simple traffic model, the main objective is mostly to determine the number of packets sent that are able to reach their destinations.

For the initial behavior evaluations, two types of mobility models were used, i.e., Manhattan Model, introduced by F. Bai, N. Sadagopan & A. Helmy, “The IMPORTANT framework for analyzing the Impact of Mobility on Performance Of Routing protocols for Adhoc Networks,” Proceedings of the 22^{nd} Annual Joint Conference of the IEEE Computer and Communications Societies (INFOCOM 2003), San Francisco, Calif., USA, 2003 and Geographic Information System (GIS)-based model designed by R. Baumann, F. Legendre & P. Sommer, “Generic mobility simulation framework (GMSF),” MobilityModels '08: Proceedings of the 1st ACM SIGMOBILE workshop on Mobility models, Hong Kong, China, May 2008. Some of the parameters used in the simulations are shown in Table 2 and Table 3. For the performance evaluation to compare JARR routing protocol with the existing position-based routing protocol GPSR (B. Karp and H. T. Kung, “GPSR: Greedy Perimeter Stateless Routing for Wireless Networks,” Proceedings of ACM/IEEE MOBICOM'00, Boston, Mass., USA, 2000, pp. 243-254), the realistic vehicle movements generated by MMTS (K. Nagel, B. Raney, A. Voellmy, N. Cetin and M. Vrtic, “Towards a microscopic traffic simulation of all of Switzerland,” Proceedings of the International Conference on Computational Science 2002 (ICCS'02), 2002, pp. 371-380) was used. Since both of these mobility model used for the performance evaluation uses realistic movements, the parameters such as node velocity and pause time are fixed and varies depending on the time of simulation.

The parameters used for performance evaluation is shown in Table 4. With a fixed map size, the number of nodes in the network is varied to produce different density conditions throughout the network. Then for the respective number of nodes set, the total number of connections allowed at any one time also differs for the simulations. For each connection, over 1000 packets will be sent and if possible, received. The number of connections allowed at a time greatly affects the network resources and puts strain on the network. Therefore, the performance of the routing protocols can be examined during these situations.

Simulation Results and Discussions

Several performance metrics were used in order to evaluate the routing protocols. The metrics used are vital to show the effectiveness of any routing protocol. The average results obtained were also compared over different parameters such as number of nodes, number of connections, velocity of nodes and beaconing rates.

The results for Packet Delivery Ratio (PDR) can be obtained with the use of equation

PDR=Total Packets Received/Total Packets Sent. (3)

Total packets sent refers to the CBR packets sent when a connection between two nodes is established. Total packets received refers to the packets that actually arrived at their destinations after they were sent. Since there are multiple connections involved, the PDR obtained refers to the average results from all the connections. At best, PDR should show a result of 1. Referring to S. R. Das, C. E. Perkins and E. M. Royer, “Performance comparison of two on-demand routing protocols for ad hoc networks,” Proceedings of the IEEE Conference on Computer Communications (INFOCOM), March 2000, pp. 3-12, the metric PDR is important because it shows the packet loss rate that then affects the maximum throughput supported by the network.

Overhead packets refers to non data packets generated throughout the simulations to assist in routing. For position-based routing, the component that generates the most overhead packets is the beaconing mechanism (H. Füβler, H. Hartenstein, J. Widmer, M. Mauve and W. Effelsberg, “Contention-Based Forwarding for Street Scenarios,” Proceedings of the 1st International Workshop on Intelligent Transportation (WIT), Hamburg, Germany, March 2004, pp. 155-160). For wireless communications with limited resources, it is important to optimize the usage of the wireless bandwidth. The number of overhead packets will affect the quality of the network due to network congestions.

End-to-end delay refers to the time it takes for a packet to travel across a network from its source to its destination. This performance metric can be used to analyze the latency of the network. It is important for the packets to arrive with the least possible delay to ensure good quality of service and enable more VANET applications to be implemented. For the simulations, the results are only taking into account the packets that have successfully reached their destinations. Therefore it might not be affected by the packet delivery ratio as even though a packet has reached its destination, it might have taken a longer route.

Number of hops refers to the number of times a packet has been forwarded before reaching its destination. The number of hops taken by a packet to reach its destination also indirectly affects the end-to-end delay of the packets. Research by M. Moske, H. Fussler, H. Hartenstein & W. Franz, “Performance measurements of a vehicular ad hoc network” Proceedings of the IEEE Semiannual Vehicular Technology Conference (VTC), May 2004, pp. 2116-2120 also showed that the number of hops affected the overall throughput of a wireless network whereby the throughput would decrease when the number of hops increased. Besides that, one of the objectives is to design a routing model that uses the fastest path instead of the shortest. Hence, this metric can also indicate whether looping has occurred and whether a packet is taking a much longer route than expected to reach its destination.

The following tables show some of the results obtained when performing the behavior evaluation. The results were also evaluated based on the performance metrics discussed.

The average packet delivery ratio for JARR was obtained for the different ratio between position and direction weights, number of nodes and velocity of nodes. Table 5 shows the average packet delivery ratio results for nodes moving at up to 36 km/h with varying number of nodes. The results show that at high density, the ratio between position and direction weights did not affect much on the packet delivery ratio. This is because as long as the nodes are mostly connected, packets can be delivered. Moreover, with an average density, JARR was shown to perform better if position has a higher weight even though the overall packet delivery ratio obtained was slightly lower.

At sparse density and low velocity, the average packet density ratio deteriorated because there were simply too few nodes to forward packets. However the main objective was to determine the effect of different ratio on the output. It has been shown that with a higher ratio of position at low velocity and sparse density, better results are produced.

Table 6 shows the different sets of results obtained when the nodes are travelling at a higher velocity in a sparse network. Overall the average end-to-end delay increased because the recovery strategy was used often in order to forward the packets. However it is shown that while considering higher weight in direction, a lower end-to-end delay can be obtained.

The average overhead packets was evaluated with fixed and adaptive beaconing mechanism in different node densities. Table 7 shows the results obtained. The notation used in the table for example 6.0E+4, means 6.0 times 10 to the power of 4, that is 60000 packets. The results showed that with a fixed beaconing mechanism, the increase in overhead packets was almost proportional to the increase in number of nodes. This is because most of the overhead packets were generated by the beaconing of nodes at a fixed interval. On the other hand, for adaptive beaconing at low density, the generated overhead packets were much higher due to higher beaconing rate to locate neighboring nodes. However, as the density increased the average overhead packets generated averages out and then decreased by a substantial amount when the density is high. The results also showed that the overhead packets generated is lower with average density.

There are several factors that could affect the results for average number of hops taken. For example in a sparse network, even though the end-to-end delay would increase, the number of hops could be lower due to packets being carried and forwarded. Table 8 shows the results for average number of hops taken in sparse and dense networks. It is shown that if nodes are moving slowly and direction has a higher priority, the number of hops will increase. Even though the paths taken could be the same, less optimal nodes could be chosen in the forwarding process that would then increase the number of hops taken. However, when the mobility of the network is increased, the number of hops taken are shown to decrease if direction of nodes has a higher weight. Besides that, the average number of hops taken are also less when compare to a dense network.

The following graphs show the results obtained for performance evaluation. For average packet delivery ratio (PDR), the results were compared over different number of connections.

FIG. 18 shows the results obtained for high density network. With minimum number of connections, JARR and GPSR produced similar good results. However, as the number of connections increases, the performance of GPSR drops at a higher rate when compared with JARR. With 20 connections, JARR is still able to maintain a PDR above 0.8 whereas for GPSR, the ratio has dropped below 0.5. This is mainly caused by the difference in beaconing mechanism in both routing protocols. JARR reduces its beaconing rate substantially in dense networks. Therefore, JARR is able to handle more connections with less network congestions caused by beaconing.

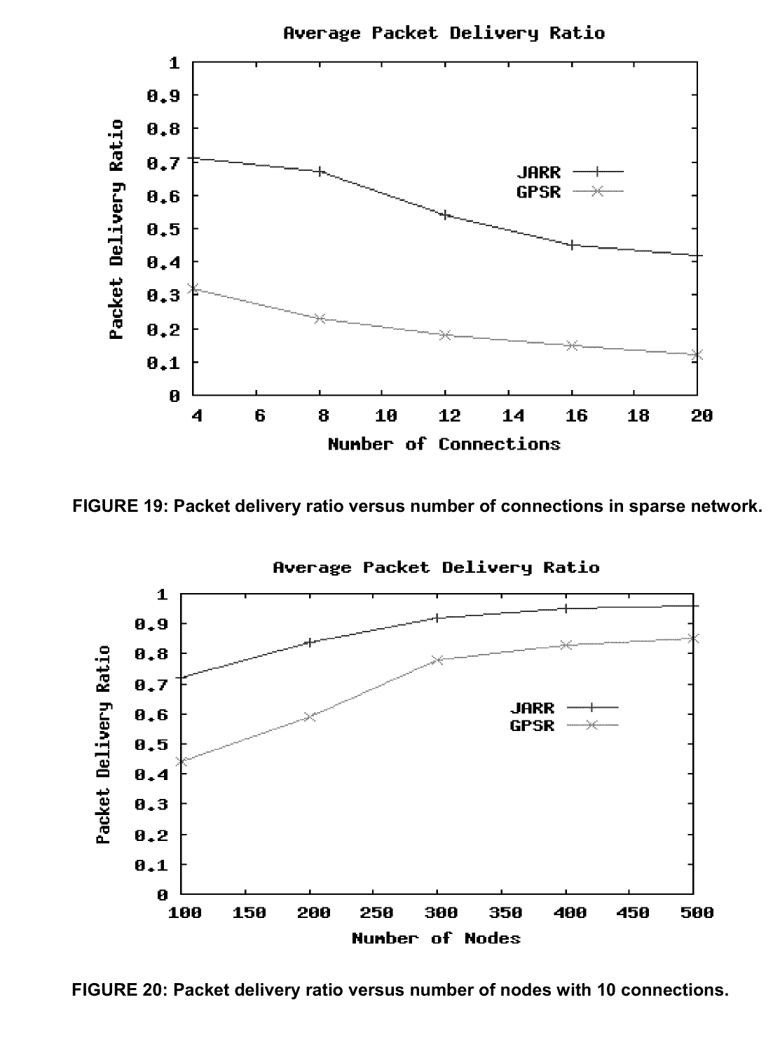

Furthermore, JARR also performed much better in a sparse network as shown in FIG. 19. The poor results shown by GPSR in sparse densities were due to its inability to cope with disconnected networks. At 20 number of connections, most packets were unable to reach their destinations. The overall performance of JARR also dropped in a sparse network and with the increased in number of connections. In a sparse network with high number of connections, the beacon rate increased substantially. Hence, more resources were spent on beaconing instead of transmitting data packets and caused the average PDR to drop. However, the average PDR for JARR was still much higher than GPSR.

Analysis in terms of PDR was further reviewed with results in FIG. 20. For both GPSR and JARR, the average PDR improved with the increase in node densities. Though with the recovery strategy of JARR that used the carry and forward method, PDR obtained by JARR at sparse conditions was much better. JARR was able to overcome temporary disconnections in the network that caused packets to be lost or dropped. In contrast, GPSR used the perimeter mode as its recovery strategy that often failed since most nodes were not connected.

For the simulations, the increase in number of simultaneous connections will increase the number of overhead packets generated. However, it is essential to study the rate in which the overhead packets scales up with number of connections. The results for overhead packets were compared over different number of nodes and number of connections.

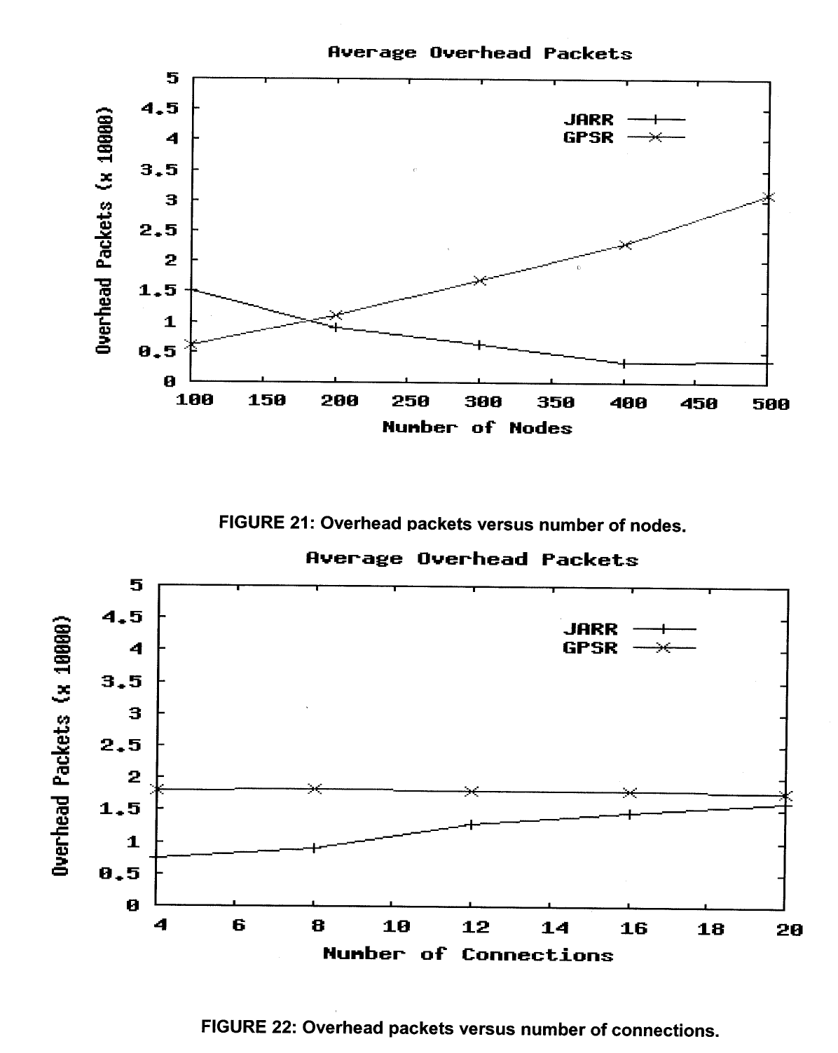

FIG. 21 shows the results for average overhead packets obtained when JARR and GPSR was compared over different network densities. Overall, GPSR generated less overhead packets in a sparse network but increases at the same rate as the number of nodes. This is because the overhead packets for GPSR are mostly affected by the beaconing mechanism. Hence the increase in number of nodes would have a direct effect on the overhead packets generated by GPSR. For JARR, more overhead packets were generated at low densities but reduce gradually with the increase in number of nodes. This is because JARR beacons at a much faster rate in a sparse network in attempts to locate neighboring nodes as soon as possible. As the network density increases, JARR beacons at a slower rate until it reaches a threshold density whereby the beaconing rate would be fixed at a slow rate.

As shown in FIG. 22, the overhead packets for JARR was also affected by the number of connections. While overhead packets for GPSR remained almost constant with the increase in number of connections, overhead packets for JARR gradually increased. This is because JARR generates additional overhead packets for density estimation and path selection purposes. Hence, if more packets were required to be forwarded, more density estimation and path selection process would occur. However with these mechanisms, even with a slight increase in overhead packets, better packet delivery ratios can be achieved.

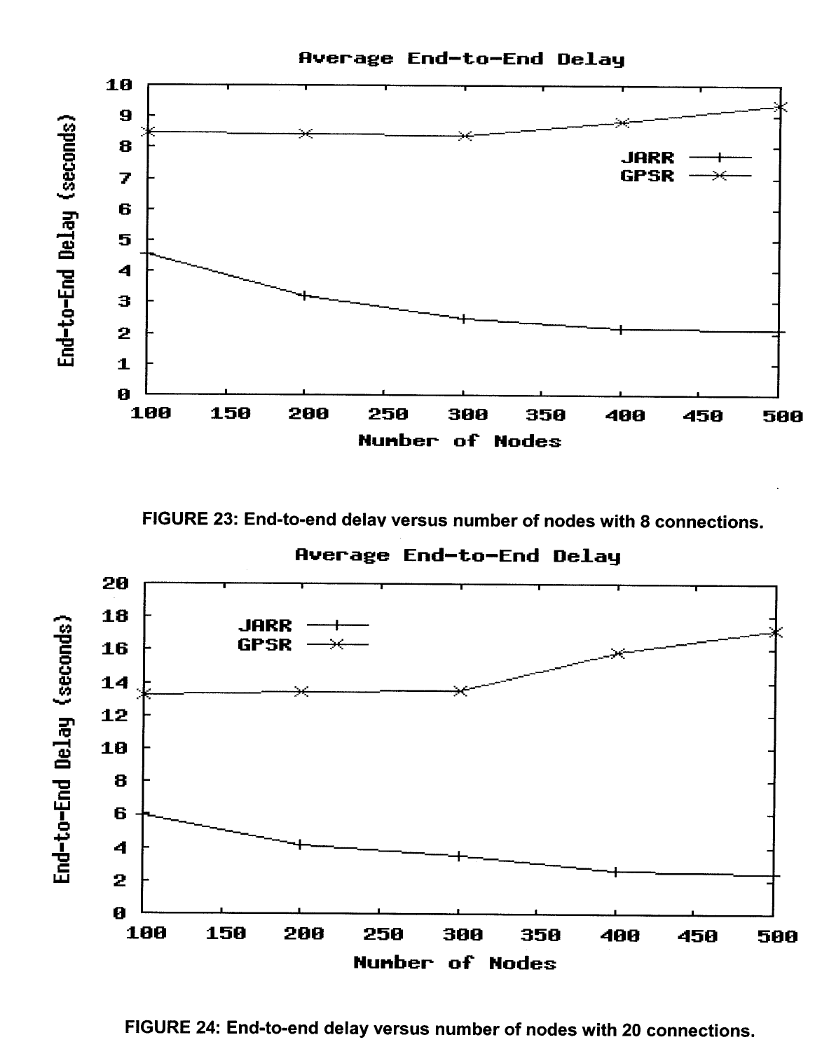

The results for end-to-end delay were compared with different number of nodes. FIG. 23 shows the results when 8 connections were used. Overall, GPSR produced much higher delays that increased slowly with the increase in number of nodes. Although GPSR was till able to deliver packets, the packets arrived with a high delay. This is due to the disconnected network conditions of a city environment that caused GPSR to use perimeter mode often. Then, packets would travel further than intended and caused a high end-to-end delay.

JARR produced much lower end-to-end delay that reduced further with the increase in network density. This is because JARR uses adaptive algorithms that take into account the direction of travel and velocity of nodes. Not affected by the connectivity of the nodes, JARR was able to forward packets through the fastest path possible. Higher delay was produced in sparse and average network networks due to packets being carried for short intervals during network disconnections.

Further review can be seen at FIG. 24 whereby the number of connections was Further review can be seen increased to 20. The performance or JARR in terms of end-to-end delay did not change substantially. However for GPSR, the delay increased further with the increase n number of nodes. This was again caused by the beaconing mechanism whereby network congestion would occur at high densities and incur higher delays.

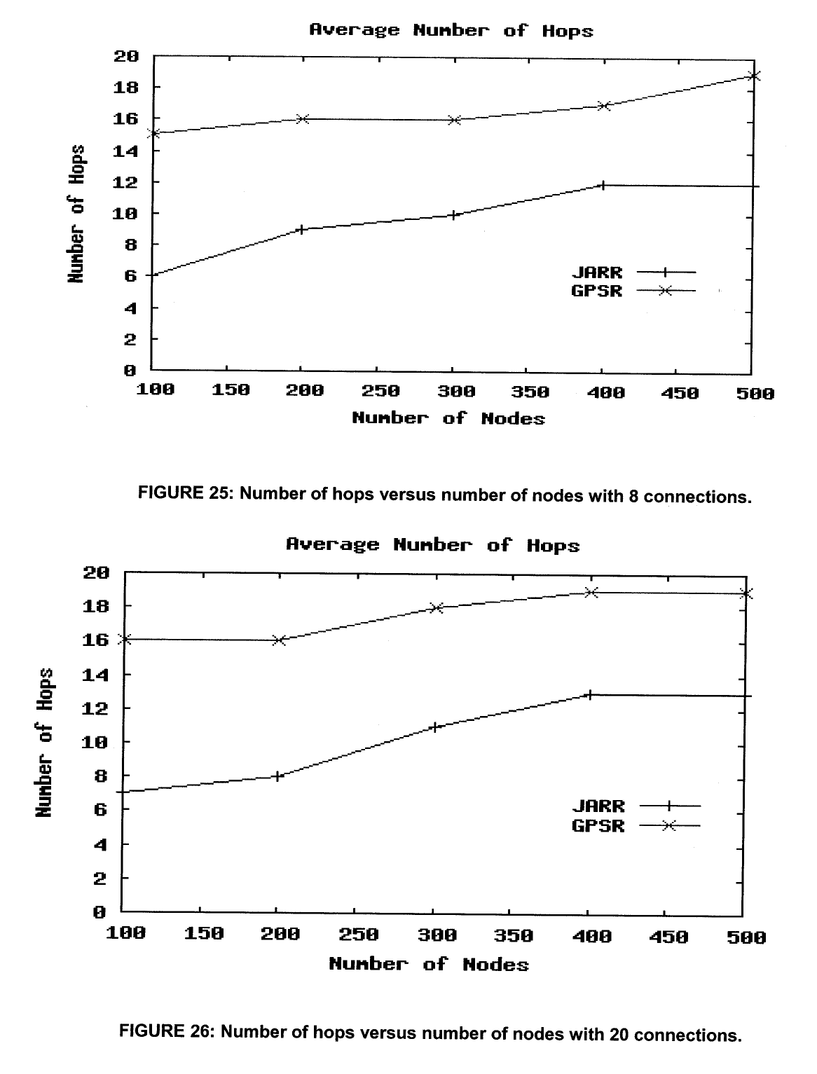

The number of hops taken by packets that arrived at their destinations was also compared with different number of nodes. The results are indirectly related to the end-to-end delay produced. As shown in FIG. 25, GPSR produced higher number of hops when compared with JARR. For GPSR, the number of hops increased with the number of nodes due to packets taking a longer route to reach their destinations.

For JARR however, the number of hops although lower, also increased with the number of hops. At low and average densities, there were more chances that packets would be carried. Although this would incur a higher latency, packets were taking less hops in order to reach their destinations. As the number of nodes increased, packets were less likely to be carried and more likely to be forwarded through the wireless channel. With packets being forwarded more frequently, lower latency were obtained.

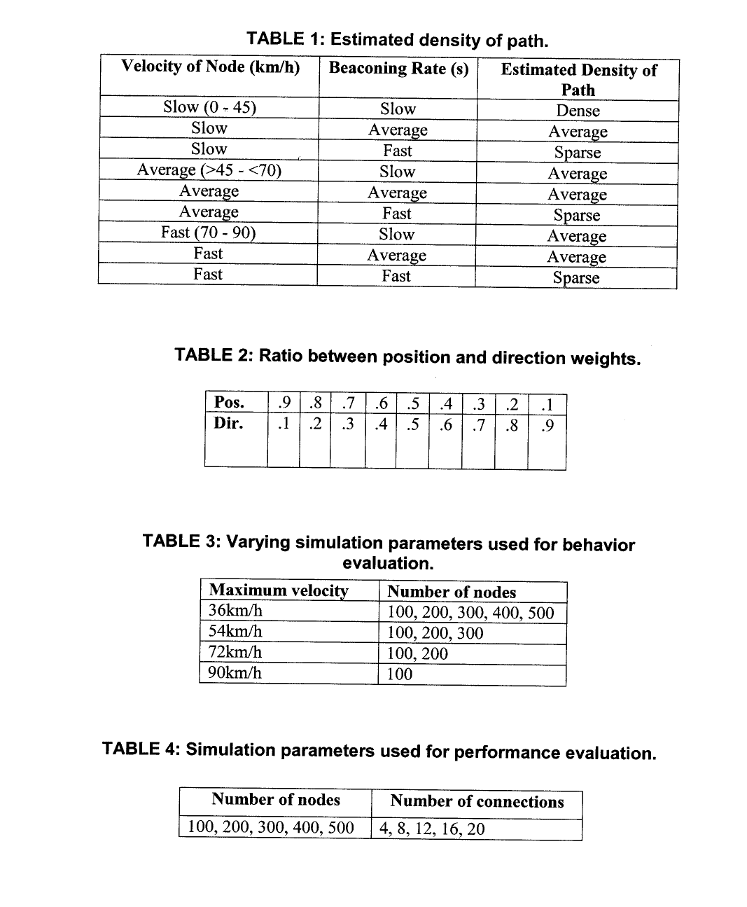

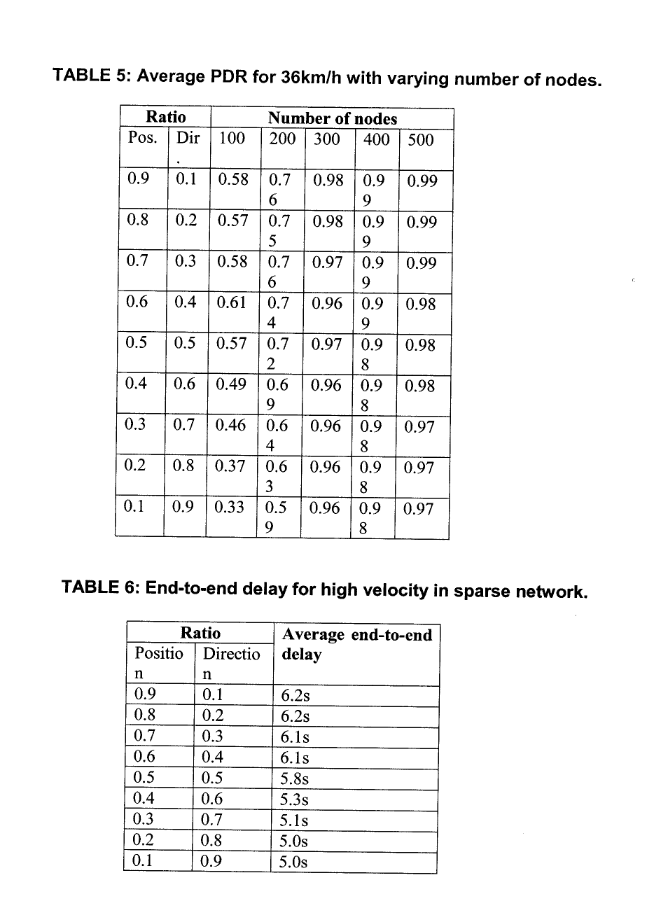

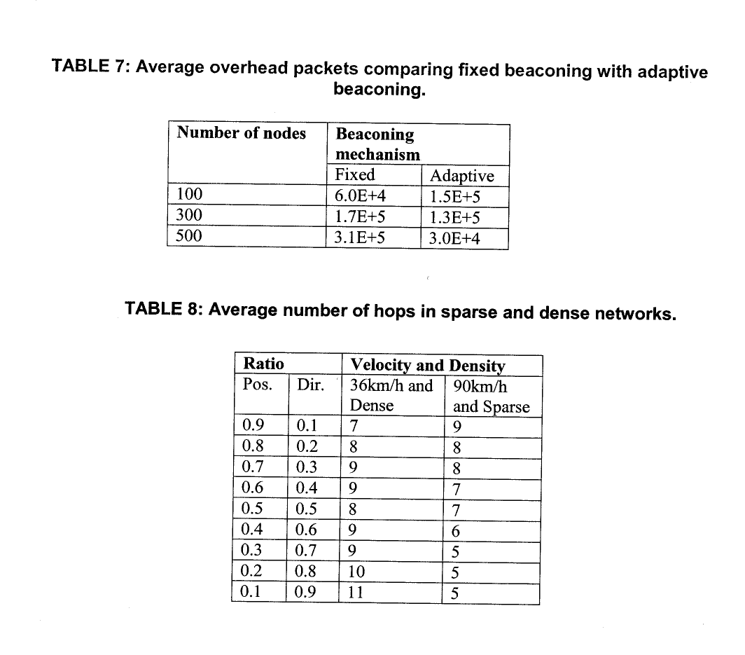

FIG. 26 shows the results for average number of hops with increased number of connections. The results show that even with increased connections among nodes, the number of hops taken by packets did not change significantly. Most delay was caused by network congestions that would incur higher delay at every forwarding node.

Overall, JARR outperformed GPSR in all four performance metrics that was compared with. Significant performance difference can be seen especially in sparse network conditions whereby nodes move at a higher velocity. Although higher overhead packets and end-to-end delay was obtained in these scenarios, JARR was able to produce a much higher packet delivery ratio. Even if nodes were assumed to move at low velocities in a sparse network, JARR was still able to produce better results. Moreover in dense network conditions, the performance of JARR increased substantially in terms of packet delivery ratio, overhead packets and end-to-end delay. Although the number of hops taken increased, this is unavoidable due to the many possible obstacles in a city environment. This was demonstrated by M. Moske, H. Fussier, H. Hartenstein & W. Franz, “Performance measurements of a vehicular ad hoc network” Proceedings of the IEEE Semiannual Vehicular Technology Conference (VTC), May 2004, pp. 2116-2120 in a real world deployment whereby the overall throughput was expectedly lower when the number of hops increased. Besides that, JARR was also able to maintain its performance for scenarios involving average densities.

### CONCLUSIONS

Junction-based Adaptive Reactive Routing (JARR), a newly proposed position-based routing protocol was designed to tackle the problem of routing for VANET in a city environment (see E. W. Dijkstra, “A note on two problems in connexion with graphs,” Numerische Mathematik, 1, 1959, pp. 269-271). JARR routes packets from one junction to another while considering the paths with optimal estimated densities. At the same time, JARR adapts to the network conditions by adjusting its beaconing rate and routing algorithms. Simulations with realistic traffic movements were performed to evaluate JARR with GPSR (B. Karp and H. T. Kung, “GPSR: Greedy Perimeter Stateless Routing for Wireless Networks,” Proceedings of ACM/IEEE MOBICOM'00, Boston, Mass., USA, 2000, pp. 243-254). The analysis of the results with different performance metrics showed JARR producing much better results among various network densities. JARR has produced promising results when implemented in a VANET city environment.

In order for more conclusive results, the proposed position-based routing protocol can be further evaluated with different simulation models such as with the use of different network topologies and radio propagation models. For this research, the two ray ground propagation model was used. The shadowing model can be used to further compare the effectiveness of the routing protocol. Standard IEEE 802.11 protocols were also used for the simulations, hence further changes can be made to the communication protocols that would further suit routing in the city environment.

This JARR routing protocol patent can be applied and implemented in a real world system with the use of equipment such as routers, wireless transmitters, laptops, GPS devices, security features and so on.

### INDUSTRIAL APPLICABILITY

The protocol has strong application in intelligent traffic management system and inter-vehicular system. There will be strong interests from automotive, logistics and traffic management industries for this protocol.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A routing strategy for vehicular ad-hoc network in a city environment, comprising: three routing modes, shortest path mode, path mode and junction mode; reactive routing is used while considering the optimal path which is the shortest.

2. The strategy of claim 1 further comprising: shortest path mode calculates the shortest distance between the source and destination node. This mode is also used to get an initial direction of travel.

3. The strategy of claim 1 further comprising: path mode calculates the next hop to be taken to forward packet to an intermediate junction.

4. The strategy of claim 1 further comprising: junction mode calculates the next intermediate junction to be taken; calculates the next hop to be taken to reach the calculated intermediate junction.

5. The strategy of claim 1, wherein choosing a next hop in path mode is based on a calculated weighted score.

6. The strategy of claim 5 further comprising: calculation involves the distance of nodes to an intermediate junction, current position of nodes, direction of travel and velocity of nodes.

7. The strategy of claim 5 further comprising: weight of position and direction of travel changes based on estimated density of vehicles on the path.

8. The strategy of claim 1 further comprising: calculating the distance of nodes to destination junction, current position of nodes, direction of travel and estimated density of path, the strategy further comprising: weight of position and direction of travel changes based on estimated density of vehicles on the path and a comparison with the optimal path when the next intermediate junction is selected.

9. A method for estimating density on a path by considering the beaconing rate of nodes and density around a node, the method comprising adaptive beaconing which is used to adjust the beaconing rate based on current network conditions.

10. The estimation method of claim 9 further comprising: density around a node is obtained by using the beaconing mechanism to obtain the number of nodes in radio range.
